(19) United States
(12) Patent Application Publication
(10) Pub. No.: US 2011/0241274 A1
(43) Pub. Date: Oct. 6, 2011

(54) SHEET FINISHING APPARATUS AND FOLD REINFORCING APPARATUS

(75) Inventor: Tomomi IIJIMA, Shizuoka-ken (JP)

(73) Assignees: Kabushiki Kaisha Toshiba, Tokyo (JP); Toshiba Tec Kabushiki kaisha, Tokyo (JP)

(21) Appl. No.: 13/075,621

(22) Filed: Mar. 30, 2011

Related U.S. Application Data
(60) Provisional application No. 61/320,274, filed on Apr. 1, 2010.

(51) Int. Cl. B41L 43/12; B41L 43/02

(52) U.S. Cl. 270/37; 270/52.26

(57) ABSTRACT

According to one embodiment, a sheet finishing apparatus includes: a saddle stapling unit configured to staple a center of a sheet bundle; a saddle folding unit configured to fold the center of the sheet bundle stapled by the saddle stapling unit; a cover configured to cover the fold which is formed by the saddle folding unit so as to be in contact with the fold; and a fold reinforcing roller configured to move along the fold while applying pressure to the fold via the cover. A large number of protrusions, tips of which project to the fold, are formed on facing surfaces of the cover that are in contact with the fold.

### CROSS-REFERENCE TO RELATED APPLICATIONS

This application is based upon and claims the benefit of priority from: U.S. provisional applications 61/320,274 filed on Apr. 1, 2010, the entire contents of which are incorporated herein by reference.

### FIELD

Embodiments described herein relate generally to a sheet finishing apparatus and a fold reinforcing apparatus.

### BACKGROUND

In the past, there has been known a sheet finishing apparatus that is set on a downstream side of an image forming apparatus such as a copying machine, a printer, or a MFP (Multi-Functional Peripheral) and applies finishing such as punching or stapling to printed sheets.

Recently, functions of the sheet finishing apparatus have been diversified. There is proposed a sheet finishing apparatus that has, in addition to the functions of punching and stapling, a function of folding for bending a part of sheets and a function of saddle stapling and saddle folding for bending sheets in the center of the sheets after stapling the center of the sheets with staples.

In the sheet finishing apparatus having the function of saddle stapling and saddle folding, it is possible to even produce (bind) a booklet from printed plural sheets.

In the saddle stapling and saddle folding proposed in the past, processing for, after stapling the center of sheets with staples or the like, folding and bending a bound section with a pair of rollers called saddle folding rollers is performed. In the processing, a tabular member called folding blade is pressed against the bound section of the sheet bundle to push the sheet bundle into a nip section of the saddle folding roller pair and fold the sheet bundle.

However, time during which a folded section of the sheet bundle is pressed by the nip section of the saddle folding roller is short. Since the entire folded section is pressed by the nip section of the saddle folding roller at a time, pressure is dispersed over the entire fold. Therefore, the fold formed by the saddle folding roller is a fold not sufficiently pressed. In particular, if the number of sheets is large or if a thick sheet is included in the sheet bundle, the sheet bundle is often incompletely folded.

As measures against this problem, there is disclosed a technique for separately providing a roller called fold reinforcing roller and reinforcing the fold formed by the saddle folding roller using the fold reinforcing roller. For example, there is also disclosed a technique for inserting the fold pushed out from the saddle folding roller into a nip of a pair of fold reinforcing rollers and moving the pair of fold reinforcing rollers along the fold while applying pressure to the fold to reinforce the fold. There is also disclosed a technique for holding the fold with two films and moving the fold reinforcing roller over the films to thereby prevent creases and scratches from occurring in the sheet bundle.

However, even if the fold is reinforced by the fold reinforcing roller, in some case, the reinforcement of the fold is still insufficient depending on the thickness of the sheet bundle or a type of the sheets. Therefore, there is a demand for a sheet finishing apparatus and a fold reinforcing apparatus that can further reinforce the fold and form a satisfactory fold.

### BRIEF DESCRIPTION OF THE DRAWINGS

In the accompanying drawings:

FIG. 1 is a perspective view of an external appearance example of an image forming apparatus according to an embodiment;

FIG. 2 is a sectional view of a configuration example of the image forming apparatus according to the embodiment;

FIG. 3 is a sectional view of a configuration example of a saddle stapling unit;

FIG. 4 is a perspective external view of the entire structure of a fold reinforcing apparatus;

FIGS. 5A and 5B are schematic sectional views for mainly explaining the structure of a supporting unit;

FIGS. 6A and 6B are schematic diagrams of a main part of a fold reinforcing apparatus according to a first embodiment;

FIG. 7 is a schematic diagram of a main part of a fold reinforcing apparatus according to a modification of the first embodiment; and

FIGS. 8A and 8B are schematic diagrams of a main part of a fold reinforcing apparatus according to a second embodiment.

### DETAILED DESCRIPTION

Embodiments of a sheet finishing apparatus and an image forming apparatus are explained below with reference to the accompanying drawings.

In general, according to one embodiment, a sheet finishing apparatus includes: a saddle stapling unit configured to staple a center of a sheet bundle; a saddle folding unit configured to fold the center of the sheet bundle stapled by the saddle stapling unit; a cover configured to cover the fold which is formed by the saddle folding unit so as to be in contact with the fold; and a fold reinforcing roller configured to move along the fold while applying pressure to the fold via the cover. A large number of protrusions, tips of which project to the fold, are formed on facing surfaces of the cover that are in contact with the fold.

### (1) Configuration of an Image Forming Apparatus

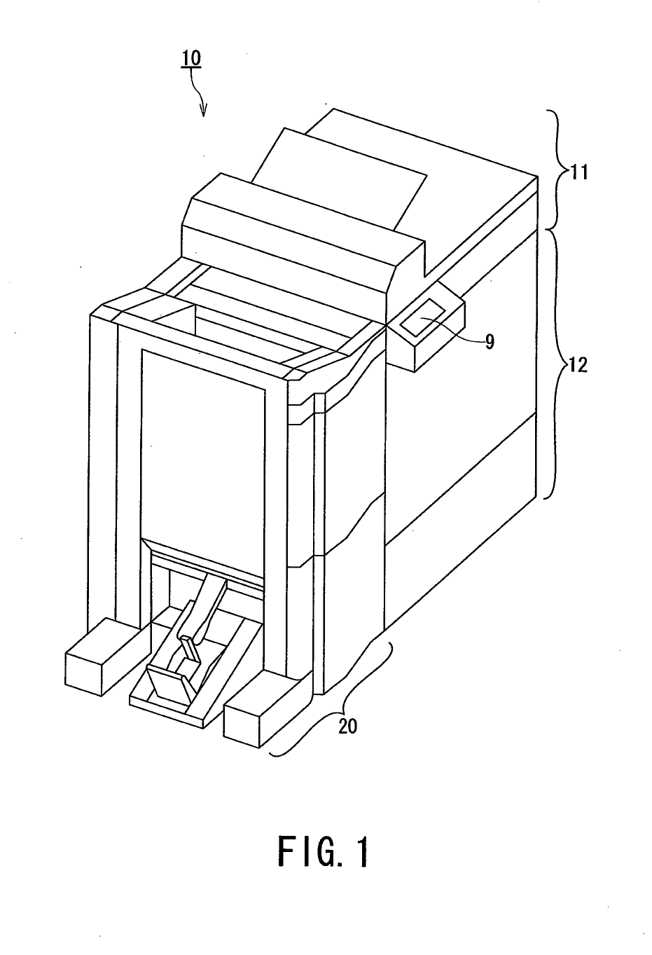

FIG. 1 is an external perspective view of a basic configuration example of an image forming apparatus 10 including a sheet finishing apparatus 20 according to an embodiment. The image forming apparatus 10 includes a reading unit 11 configured to read an original document, an image forming unit 12 configured to print image data of the read original document on sheets in an electrophotographic system, and the sheet finishing apparatus 20 configured to apply finishing such as sorting, punching, folding, or saddle stapling to the printed sheets. The image forming unit 12 includes an operation unit 9 with which a user performs various kinds of operation.

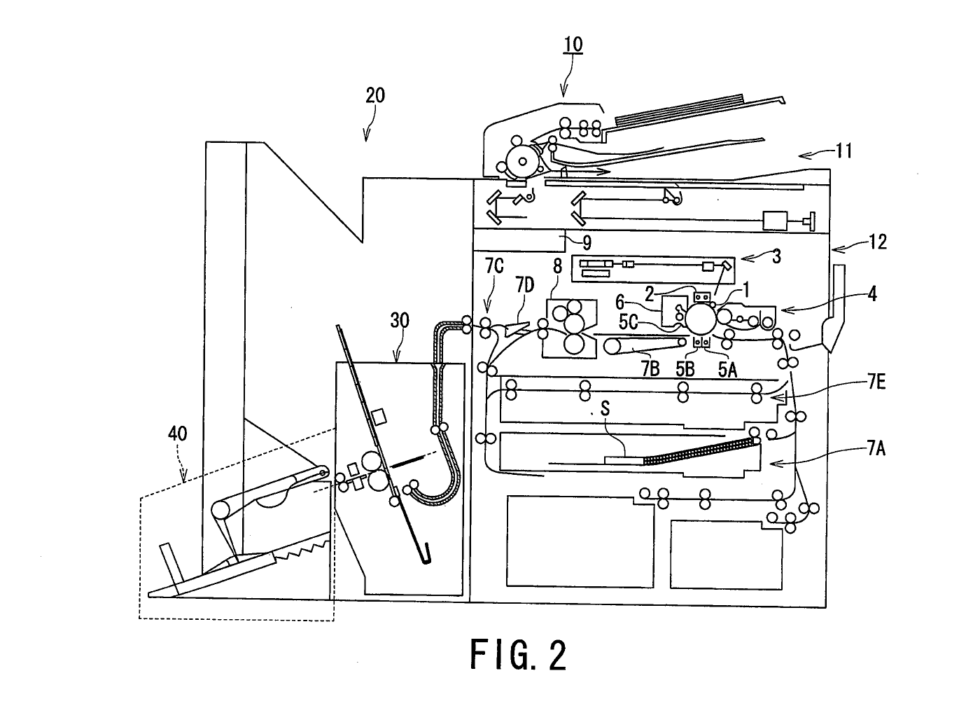

FIG. 2 is a sectional view of a detailed configuration example of the image forming apparatus 10.

The image forming unit 12 of the image forming apparatus 10 includes a photoconductive drum 1 near the center of the image forming unit 12. A charging unit 2, an exposing unit 3, a developing unit 4, a transfer unit 5A, a charge removing unit 5B, a separating pawl 5C, and a cleaning unit 6 are disposed around the photoconductive drum 1. A fixing unit 8 is provided on a downstream side of the charge removing unit 5B. Image formation processing is performed by these units in a procedure schematically explained below.

First, the charging unit 2 uniformly charges the surface of the photoconductive drum 1. Meanwhile, an original document read by the reading unit 11 is converted into image data. The image data is input to the exposing unit 3. The exposing unit 3 irradiates a laser beam corresponding to the level of the image data on the photoconductive drum 1 and forms an electrostatic latent image on the photoconductive drum 1. The electrostatic latent image is developed with a toner supplied from the developing unit 4. A toner image is formed on the photoconductive drum 1.

A sheet stored in a sheet storing unit 7 is conveyed to a transfer position (a gap between the photoconductive drum 1 and the transfer unit 5A) via several conveying rollers. In the transfer position, the transfer unit 5A transfers the toner image from the photoconductive drum 1 onto the sheet. The charge removing unit 5B removes charges on the surface of the sheet having the toner image transferred thereon. The separating pawl 5C separates the sheet from the photoconductive drum 1. Thereafter, an intermediate conveying unit 7B conveys the sheet. The fixing unit 8 heats and presses the toner image to fix the toner image on the sheet. The sheet subjected to the fixing is discharged from a discharge unit 7C and output to the sheet finishing apparatus 20.

The cleaning unit 6 removes, at the downstream of the separating pawl 5C, a developer remaining on the surface of the photoconductive drum 1. The photoconductive drum 1 is prepared for the next image formation.

If duplex printing is performed, a conveying-path switching plate 7D causes the sheet having the toner image fixed thereon to diverge from a normal discharge passage. A reversal conveying unit 7E switches back and reverses the front and back of the sheet. Printing processing same as that in simplex printing is applied to the rear side of the reversed sheet. The sheet is output from the discharge unit 7C to the sheet finishing apparatus 20.

The sheet finishing apparatus 20 includes a saddle stapling unit 30 and a sheet-bundle placing unit 40.

The saddle stapling unit 30 performs processing for stapling, with staples, the center of plural printed sheets discharged from the image forming unit 12 and thereafter saddle-folding the sheets to form a booklet.

The booklet saddle-stapled by the saddle stapling unit 30 is output to the sheet-bundle placing unit 40. The bound booklet is finally placed on the sheet-bundle placing unit 40.

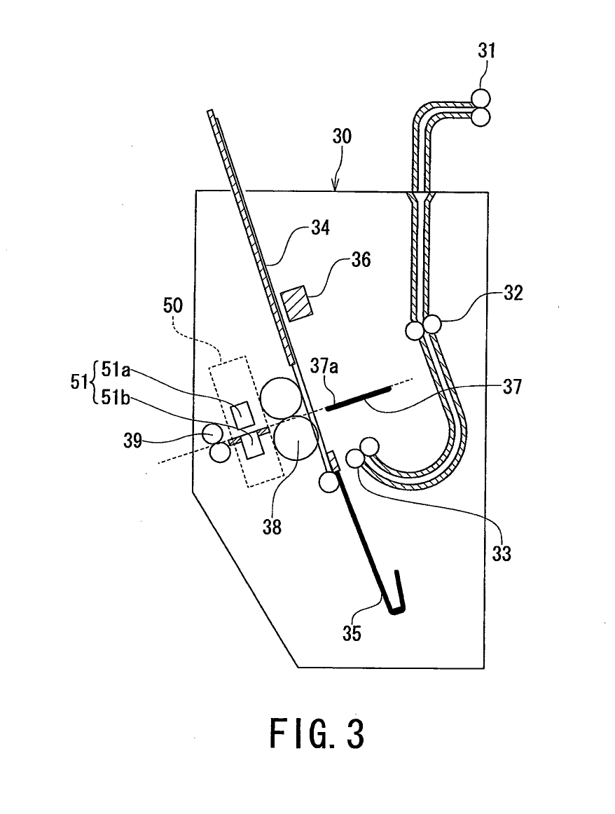

FIG. 3 is a sectional view of a detailed configuration example of the saddle stapling unit 30.

In the saddle stapling unit 30, an inlet roller pair 31 receives a sheet discharged from the discharge unit 7C of the image forming unit 12 and passes the sheet to an intermediate roller pair 32. The intermediate roller pair 32 passes the sheet to an outlet roller pair 33. The outlet roller pair 33 delivers the sheet to a standing tray 34 having a tilting placing surface. The leading end of the sheet moves upward along the tilt of the standing tray 34.

A stacker 35 stays on standby below the standing tray 34. The stacker 35 receives the lower end of the sheet switched back and dropping downward along the tilt of the standing tray 34.

A stapler (a saddle stapling unit) 36 is disposed in the middle of the standing tray 34. When a sheet bundle is saddle-stapled (stapled), the position of the stacker 35 is adjusted such that a position of the sheet bundle that should be stapled (the center in the vertical direction of the sheet bundle) faces the stapler 36.

After the sheet bundle is saddle-stapled by the stapler 36, the stacker 35 descends until a position of the sheet bundle that should be folded next (a position in the center in the vertical direction of the sheet bundle where staples have been driven in) reaches the front of a saddle folding blade 37.

When the position that should be folded reaches the front of the saddle folding blade 37, a distal end 37a of the saddle folding blade 37 pushes in a surface that should be an inner surface after the sheet bundle is bent.

A folding roller pair 38 is provided ahead in a traveling direction of the saddle folding blade 37. The sheet bundle pushed in by the saddle folding blade 37 is rolled into a nip section of the folding roller pair 38. A fold is formed in the center of the sheet bundle. The saddle folding blade 37 and the folding roller pair 38 configure a saddle folding unit.

The sheet bundle having the fold formed thereon by the folding roller pair 38 is further conveyed to a fold reinforcing apparatus 50 provided on the downstream side of the folding roller pair 38. The sheet bundle conveyed to the fold reinforcing apparatus 50 is temporarily stopped from being conveyed.

The fold reinforcing apparatus 50 includes a fold reinforcing roller 51 (an upper roller (a second roller) 51a and a lower roller (a first roller) 51b). The fold reinforcing roller 51 moves in a direction orthogonal to the conveying direction of the sheet bundle (a direction along the line of the fold) while pressing the fold and reinforces the fold.

The sheet bundle having the fold reinforced by the fold reinforcing apparatus 50 is started to be conveyed again. The sheet bundle is drawn by a discharge roller pair 39 and output to the sheet-bundle placing unit 40. The saddle-stapled sheet bundle (booklet) is placed on the sheet-bundle placing unit 40.

### (2) Fold Reinforcing Apparatus

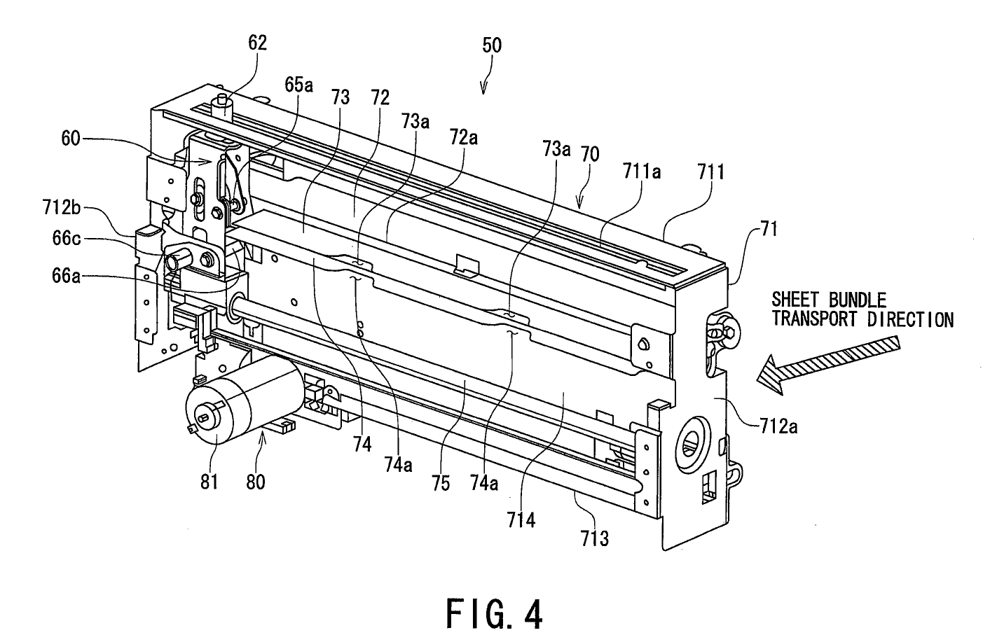

FIG. 4 is a perspective external view of the entire structure of the fold reinforcing apparatus 50. The fold reinforcing apparatus 50 includes a fold reinforcing roller unit 60 (hereinafter simply referred to as roller unit 60), a supporting unit 70, and a driving unit 80.

The roller unit 60 includes the fold reinforcing roller 51. The roller unit 60 nips the fold of the sheet bundle, which is pushed out from the folding roller pair 38 provided upstream, with the fold reinforcing roller 51 and presses the fold. The roller unit 60 moves along the fold to reinforce the fold.

The supporting unit 70 slidably supports the roller unit 60 in the direction of the fold. The supporting unit 70 includes a holding member for the sheet bundle and structure members of the entire fold reinforcing apparatus 50.

The driving unit 80 includes a driving motor 81. The driving unit 80 drives the roller unit 60 along the fold with the driving motor 81.

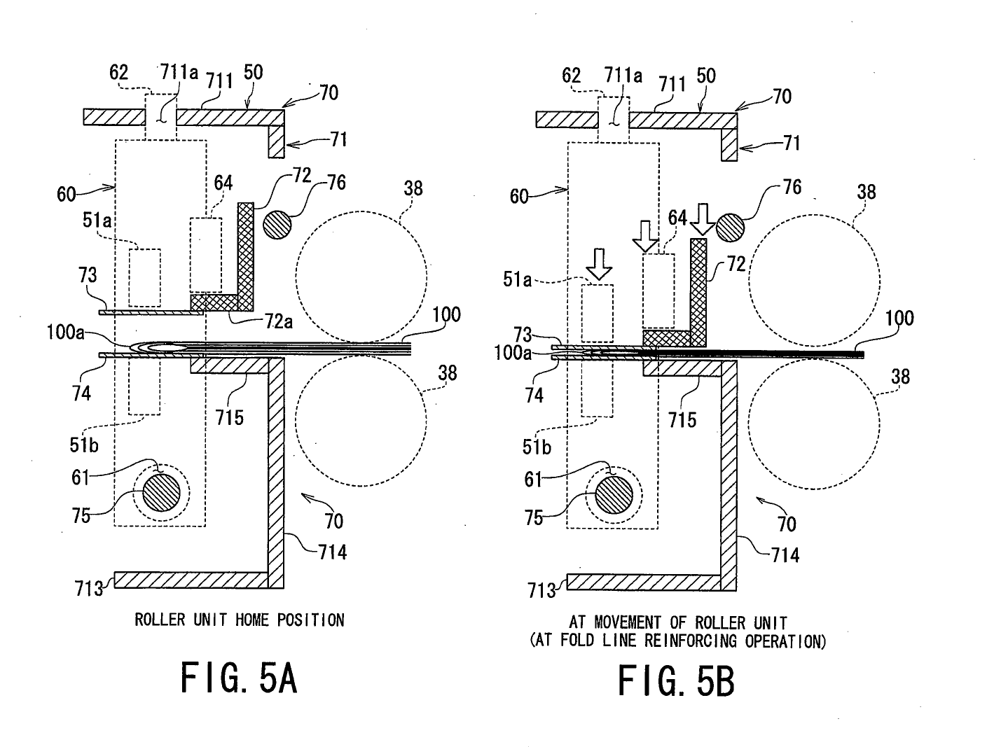

Among the roller unit 60, the supporting unit 70, and the driving unit 80, first, the structure of the supporting unit 70 is explained with reference to FIGS. 4 and 5A and 5B. FIGS. 5A and 5B are schematic sectional views for mainly explaining the structure of the supporting unit 70. FIG. 5A is a sectional view in which the roller unit 60 is present in a home position (a standby position: a position at the left end in FIG. 4). FIG. 5B is a sectional view in which the roller unit 60 is moving (reinforcing the fold).

The supporting unit 70 includes a frame 71. The frame 71 includes a top plate 711, left and right side plates 712a and 712b, a bottom plate 713, an inner plate 714, a sheet-bundle placing table 715 (see FIGS. 5A and 5B, etc.).

A supporting hole 711a extending in a longitudinal direction of the top plate 711 is provided in the top plate 711.

A supporting shaft 75 configured to support the roller unit 60, a conveyance guide 72 L-shaped in section, a driving shaft 76 (see FIGS. 5A and 5B, etc.) for driving the conveyance guide 72 in the vertical direction, and the like are provided between both the side plates 712a and 712b.

A cover of a thin tabular member (an upper cover 73) extends from a bottom plate 72a of the conveyance guide 72. A similar cover of a thin tabular member (a lower cover 74) extends from the sheet placing table 715.

As shown in FIGS. 5A and 5B, a fold 100a of a sheet bundle 100 is held between the upper cover 73 and the lower cover 74. The fold 100a is pressed by the fold reinforcing roller 51 (the upper roller 51a and the lower roller 51b) via the upper cover 73 and the lower cover 74 and reinforced. Occurrence of scratches and creases in the fold 100a and in near the fold 100a is prevented by pressing the fold 100a via the upper cover 73 and the lower cover 74.

Cutouts 73a and 74b are provided at the distal ends of the upper cover 73 and the lower cover 74. The cutouts 73a and 74b are provided in positions corresponding to positions of staples of the fold 100a to prevent the upper cover 73 and the lower cover 74 from being damaged by the staples.

The position of the lower roller 51b is fixed in the thickness direction of the sheet bundle 100. On the other hand, the upper roller 51a can move in the thickness direction of the sheet bundle 100. The upper roller 51a is urged in the direction toward the lower roller 51b by elastic force of a not-shown spring. The upper roller 51a rotates and moves in the direction of the fold 100a while applying pressure to the fold 100a via the upper and lower covers 73 and 74 to reinforce the fold 100a.

The upper roller 51a and the lower roller 51b are formed of, for example, hard resin or metal.

A through hole 61 for inserting the supporting shaft 75 is provided in a lower part of the roller unit 60. A supporting roller 62 for maintaining attitude angles of the roller unit 60 constant is provided in an upper part of the roller unit 60. The supporting roller 62 moves along the supporting hole 711a provided in the top plate 711.

The position of the roller unit 60 (excluding a position change in the moving direction) and attitude angles of three axes are regulated to be constant by the supporting shaft 75 and the through hole 61, and the supporting hole 711a and the supporting roller 62 even during the movement of the roller unit 60.

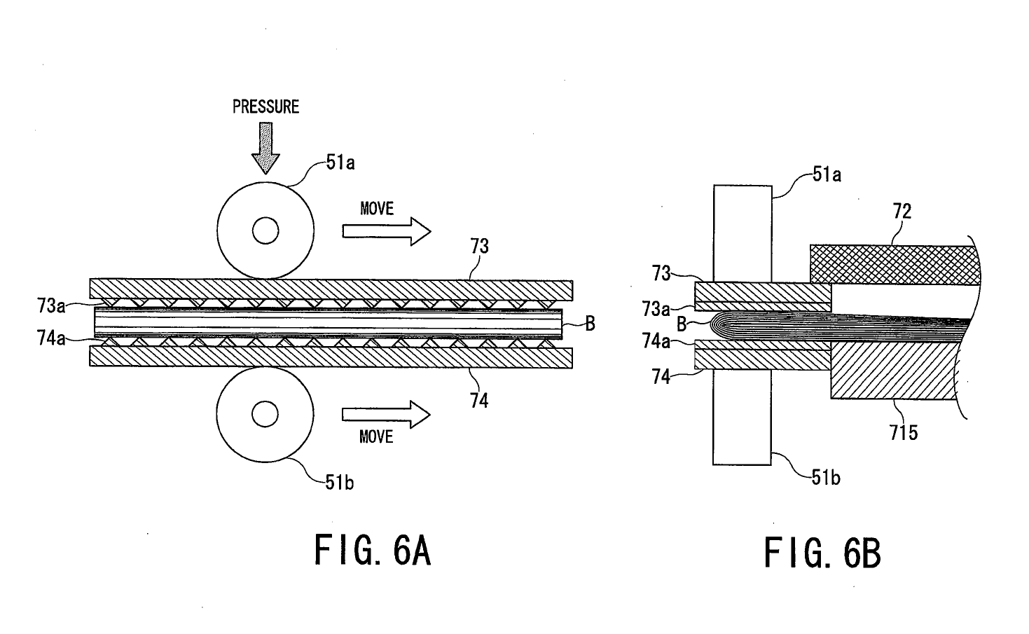

FIG. 6A is a schematic view of a main part of the fold reinforcing apparatus 50 according to a first embodiment viewed from the front side in a conveying direction of a sheet. FIG. 6B is a schematic sectional view of the main part of the fold reinforcing apparatus 50 viewed from a direction orthogonal to the conveying direction of the sheet.

As explained above, the fold reinforcing apparatus 50 includes the cover configured to cover a fold of a sheet bundle B, which is formed by a saddle folding unit, to be in contact with the fold. The fold reinforcing apparatus 50 includes the fold reinforcing roller 51 configured to move along the fold while applying pressure to the fold via the cover.

The cover includes the upper cover 73 configured to cover the fold from above and the lower cover 74 configured to cover the fold from below. The upper cover 73 and the lower cover 74 hold the fold. The fold reinforcing roller 51 includes the upper roller 51a and the lower roller 51b. The upper roller 51a and the lower roller 51b move along the fold while applying pressure to the fold via the upper cover 73 and the lower cover 74 to reinforce the fold.

As shown in FIG. 6A, a large number of protrusions, tips of which project to the fold, are formed on facing surfaces of the cover (the upper cover 73 and the lower cover 74) that are in contact with the fold. The shape of the large number of protrusions is, for example, a shape in which a large number of ridges are arranged in parallel. A ridge line of the ridges is arranged in a direction orthogonal to the fold.

The shape of the protrusions formed on the facing surfaces of the upper cover 73 and the lower cover 74 is formed in a shape having a pointed tip like a ridge shape triangular in section. This makes it possible to cause concentrated weighting at the tips of the ridges. Larger pressure is applied to the fold. As a result, reinforcement of the fold is further facilitated and a sharper fold can be formed than a method in the past for holding the fold with a cover having flat facing surfaces on which protrusions are not formed.

Both the upper cover 73 and the lower cover 74 are thin tabular members. A material of the upper cover 73 and the lower cover 74 is not specifically limited and may be, for example, metal or plastic or may be a flexible film member such as film-like polyethylene terephthalate (PET).

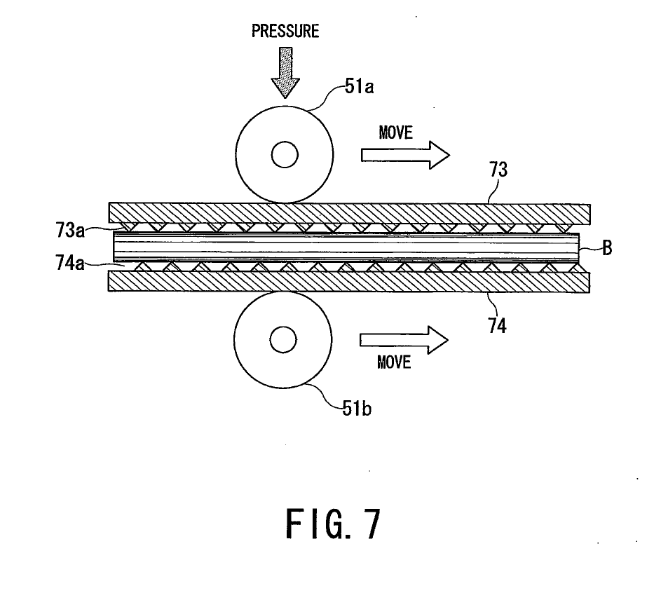

FIG. 7 is a diagram of a modification of the upper cover 73 and the lower cover 74 explained above. In this modification, each of the positions of the tips of the ridges of the upper cover 73 is roughly arranged in the position of a hollow between the adjacent ridges of the lower cover 74. In other words, the tips of the ridges are arranged in alternate positions in the upper cover 73 and the lower cover 74. With this configuration, the tips of the ridges can enter deeper into the fold and a sharper fold can be formed.

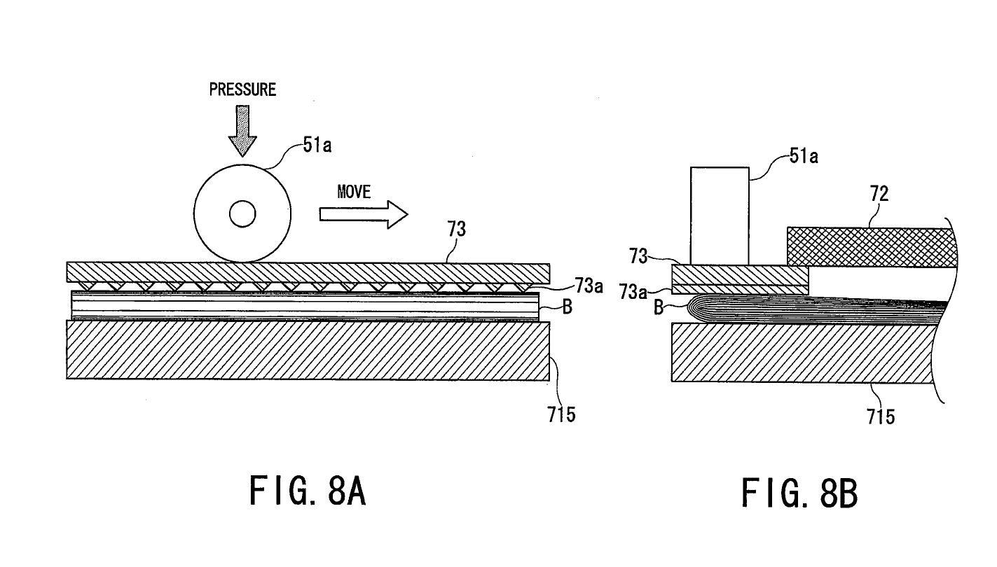

FIGS. 8A and 8B are diagrams of a main part of the configuration of the fold reinforcing apparatus 50 according to a second embodiment. In the second embodiment, the fold reinforcing roller 51 includes only the upper roller 51a. The cover includes only the upper cover 73. Meanwhile, the distal end of the placing table 715 further extends in the conveying direction of a sheet bundle than that in the first embodiment explained above.

In the second embodiment, the upper cover 73 and the placing table 715 hold a fold. The upper roller 51a moves along the fold while applying pressure to the fold via the upper cover 73. In the second embodiment, as in the first embodiment, a large number of protrusions, tips of which project to the fold, are formed on a facing surface of the upper cover 73. The shape of the large number of protrusions is the same as that in the first embodiment. For example, the shape is a shape in which a large number of ridges are arranged in parallel. A ridge line of the ridges is arranged in a direction orthogonal to the fold.

In the second embodiment, as in the first embodiment, concentrated weighting occurs at the tips of the protrusions. Thus, satisfactory fold can be formed.

As explained above, with the sheet finishing apparatus and the fold reinforcing apparatus according to the embodiments, it is possible to further reinforce a fold and form a satisfactory fold.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finishing apparatus comprising:
a saddle stapling unit configured to staple a center of a sheet bundle;
a saddle folding unit configured to fold the center of the sheet bundle stapled by the saddle stapling unit;
a cover configured to cover the fold which is formed by the saddle folding unit so as be in contact with the fold, the cover having a surface facing the fold, the surface having a large number of protrusions, and tips of the protrusions projecting to the fold; and
a fold reinforcing roller configured to move along the fold while applying pressure to the fold via the cover.

2. The apparatus according to claim 1, wherein a shape of the large number of protrusions is a shape in which a large number of ridges are arranged in parallel.

3. The apparatus according to claim 2, wherein each ridge line of the ridges is arranged in a direction orthogonal to the fold.

4. The apparatus according to claim 1, wherein
the cover includes an upper cover configured to cover the fold from above and a lower cover configured to cover the fold from below, the upper cover and the lower cover holding the fold, and
the fold reinforcing roller includes an upper roller and a lower roller configured to apply pressure to the fold via the upper cover and the lower cover.

5. The apparatus according to claim 4, wherein
a shape of the large number of protrusions formed on the upper cover and the lower cover is a shape in which a large number of ridges, a ridge line of which is orthogonal to the fold, are arranged in parallel, and
each of positions of tips of the ridges of the upper cover is arranged in a position of a hollow between the adjacent ridges of the lower cover.

6. The apparatus according to claim 1, further comprising a placing table on which the sheet bundle having the fold formed thereon by the saddle folding unit is placed, wherein
the cover is an upper cover configured to cover the fold from above, the upper cover and the placing table holding the fold, and
the fold reinforcing roller is an upper roller configured to apply pressure to the fold via the upper cover.

7. The apparatus according to claim 1, wherein the cover is a thin tabular member.

8. The apparatus according to claim 5, wherein each of the upper cover and the lower cover is a thin tabular member.

9. The apparatus according to claim 2, wherein the cover is made of a plastic member.

10. The apparatus according to claim 2, wherein the cover is made of a flexible film member.

11. A fold reinforcing apparatus comprising:
a cover configured to cover a fold which is formed by folding a center of a sheet bundle so as be in contact with the fold, the cover having a surface facing the fold, the surface having a large number of protrusions, and tips of the protrusions projecting to the fold; and
a fold reinforcing roller configured to move along the fold while applying pressure to the fold via the cover.

12. The apparatus according to claim 11, wherein a shape of the large number of protrusions is a shape in which a large number of ridges are arranged in parallel.

13. The apparatus according to claim 12, wherein each ridge line of the ridges is arranged in a direction orthogonal to the fold.

14. The apparatus according to claim 11, wherein
the cover includes an upper cover configured to cover the fold from above and a lower cover configured to cover the fold from below, the upper cover and the lower cover holding the fold, and
the fold reinforcing roller includes an upper roller and a lower roller configured to apply pressure to the fold via the upper cover and the lower cover.

15. The apparatus according to claim 14, wherein
a shape of the large number of protrusions formed on the upper cover and the lower cover is a shape in which a large number of ridges, a ridge line of which is orthogonal to the fold, are arranged in parallel, and
each of positions of tips of the ridges of the upper cover is arranged in a position of a hollow between the adjacent ridges of the lower cover.

16. The apparatus according to claim 11, further comprising a placing table on which the sheet bundle having the fold formed thereon by the saddle folding unit is placed, wherein
the cover is an upper cover configured to cover the fold from above, the upper cover and the placing table holding the fold, and
the fold reinforcing roller is an upper roller configured to apply pressure to the fold via the upper cover.

17. The apparatus according to claim 11, wherein the cover is a thin tabular member.

18. The apparatus according to claim 15, wherein each of the upper cover and the lower cover is a thin tabular member.

19. The apparatus according to claim 12, wherein the cover is made of a plastic member.

20. The apparatus according to claim 12, wherein the cover is made of a flexible film member.
